(19) United States
(12) Patent Application Publication
(10) Pub. No.: US 2015/0015573 A1
(43) Pub. Date: Jan. 15, 2015

(54) VISUALLY ADAPTIVE SURFACES

(71) Applicants: Robert Burtzlaff, San Jose, CA (US); Carmen Falcone, Belmont, MA (US)

(72) Inventors: Robert Burtzlaff, San Jose, CA (US); Carmen Falcone, Belmont, MA (US)

(21) Appl. No.: 14/380,374

(22) PCT Filed: Feb. 22, 2013
(86) PCT No.: PCT/US13/27334

§ 371 Date: Aug. 22, 2014

Related U.S. Application Data
(60) Provisional application No. 61/602,499, filed on Feb. 23, 2012.

(51) Int. Cl. G06T 15/00

(52) U.S. Cl. CPC G06T 15/005; G06T 2200/16
USPC 345/419; 345/581

(57) ABSTRACT

A display system can include an optionally removable display that at least partially conforms to a surface of an article. The article and display can be non-flat, having a curved or complex conforming shape. A processing module can automatically create images based on a set of rules operating on at least one of stored user settings, input from a user, local sensor data including but not limited to images captured by a user, or social or other network derived data. An intermediate image can be created for approval by a user, and the image can be modified to conform to display surface for enhanced visual appearance, fashion coordination, advertising, and/or branding of the article supporting the display.

### TECHNICAL FIELD

This invention relates in general to a display device, and more particularly to a display device capable of using various types of information, including but not limited to user, social, sensor, or location derived information to define or modify the presented image, pattern or graphic.

### BACKGROUND

Flexible displays capable of conforming to a contoured surface have been disclosed. For example, drapable liquid crystal transfer display films are disclosed in U.S. Pat. No. 7,796,103, which has a display film that may be transferred by lamination or otherwise onto a substrate. The display film is formed of a stack of layers that can include different types, arrangements, and functionality within the stack depending upon factors including the characteristics of the substrate (e.g., upper or lower, transparent or opaque, substrates) and addressing of the display (e.g., active or passive matrix, electrical or optical addressing). The layers of the stacked display film include one or more electrode layers and one or more liquid crystal layers and, in addition, may include various combinations of an adhesive layer, preparation layer, casting layer, light absorbing layer, insulation layers, and protective layers. The display film may be mounted onto flexible or drapable substrates such as fabric and can itself be drapable.

Bistable displays such as disclosed in U.S. Pat. No. 7,7917,89, titled “Multi-color electrophoretic displays and materials for making the same” are also known. As disclosed, such displays include a multi-color encapsulated electrophoretic display which includes at least one cavity containing at least three species of particles, the particles having substantially non-overlapping electrophoretic mobilities. The multi-color display predominately displays one of the species of particles in response to a sequence of electrical pulses controlled in both time and direction of the electric field. In certain disclosed embodiments, at least three species of particles such as magenta, cyan, and yellow particles are provided. Such displays are highly flexible, reflective (using available light rather than powered backlights or powered light emission) and can be manufactured easily on flexible substrates.

### DISCLOSURE OF INVENTION

One disclosed embodiment of a display system includes a display that at least partially conforms to a surface of an article. Images are presented on the display using a processing module to automatically create images based on a set of rules. These rules can operate on local or non-local (remote) data, stored user settings, input from a user, local sensor data such as images captured by a user, or social or other network derived data.

In certain embodiments the display can be based on conventional LCD, OLED, or bistable display technology. Processing module control of multiple displays, remotely or wirelessly connected displays, tiled displays, and/or displays that can be integrated or separated from the processing module are contemplated. In other embodiments, curved or otherwise three dimensional displays that can be wrapped, rolled or arranged to conform to a complex, non-flat surface are used. In such embodiments an intermediate image or images can be created for approval by a user, with the approved image being modified to conform to the curved or non-flat display surface.

Other embodiments provide for automatic or semi-automatic algorithmic control of the display using an expert system or other suitable control scheme that can use the stored user settings, input from a user, local sensor data such as images captured by a user, or social or other network derived data to provide a display presentation. The image can be modified to take into account visual properties of curved or non-flat displays. For example, patterns can adjusted to smoothly wrap or tile, images resized and centered on flat, non-curved portions of the display, curved borders can be colored to accentuate or minimize the perceived display curvature. In other embodiments, image data used by the processing module can include, but is not limited to, local images captured by a user with a camera, and/or non-local data. In certain embodiments data may be derived from or provided by social networks or other internet mediated or distributed data sources. User input can be provided at various stages, including creation and display of an intermediate image for approval by a user. In other embodiments, the image can be adjusted in response to a real-time feedback loop involving the display in the field of view of a camera providing data to the processing module.

As will be appreciated, the processing module can inject elements of randomness into the image creation process. As a result, intermediate images may contain colors or patterns that are not present in any of the input data or that would not otherwise result as part of a deterministic image creation process. Rule-based or expert systems that possess automated learning capability and adapt to changing user preferences, socially derived data, user selection history (of intermediate images), or the like are also contemplated. In certain embodiments, the intermediate image is presented to a user for approval, followed by image post-processing to compensate for visual characteristics of the article attached display, with data relevant to the selected or post-processed image remotely stored for later retrieval by the user or others, or retrieved automatically by processing modules as part of assembling inputs for subsequent image creation.

Low cost, low power displays and mobile or other computational devices continue to expand in numbers, capability, and frequency of interactions with users or other autonomous agents. As this occurs, users are demanding more than clunky, indistinguishable, mass produced, and merely utilitarian devices, and are instead purchasing devices for both practical purposes and as fashion accessories or personal visual statements. Devices should be easily reconfigurable to reflect personal or socially desirable styles or trending fashions, or to allow for greater aesthetic effect. Such reconfigurable device should be able to be used alone or in combination with other devices or users.

Rather than rely solely on fixed design elements such as the color of a plastic casing, or the presence of black or silvered borders on a phone, tablet, or other device, images presented on its display surface can be an integral part of the aesthetic visual presentation of the device. Desired visual effects, including patterns, logos, colors, images, or the like can be displayed to increase user satisfaction, provide a form of self-expression for the user, provide product promotion, act as a status symbol, or provide a group affiliation signal. Such visual effects can be used with devices that have non-flat, curved, conformable or removable displays. In preferred embodiments, the display surface can present images that are directly selected by the user from a range of images, or even automatically controlled by expert systems using social or other network derived data as input. Information relevant to image selection by the user, or post-processing image adjustments to better fit an image to a particular article-attached display can be stored for later use by the user, other users, or automatically by processing modules, so long as the data is stored in an appropriately accessible database.

Advantageously, disclosed embodiments provide a system, components, and processes suitable for automatically or semi-automatically creating images and adjusting those images for display on mobile or non-mobile articles. Automatic, semi-automatic, or user control of displayable images based on local or non-local (remote) data, stored user settings, input from a user, local sensor data such as images captured by a user, or social or other network derived data permits a great flexibility and relevance in article appearance. In addition to purely aesthetic or appearance customization, changes in display appearance can be used to provide useful information. For example, color changes in the display can be linked to geographical areas (e.g. moving from “Blue sector parking area” to Red sector, with suitable color change), patterns can be linked to time of day, or flashing or dynamic pattern changes can indicate lost device status. The foregoing advantages are merely non-limiting examples, and further advantages and usage scenarios are disclosed elsewhere in the disclosure.

### BRIEF DESCRIPTION OF DRAWINGS

FIG. 1 illustrates an embodiment of a conforming skinnable display wrappable around a cellular telephone or similar device;

FIG. 2 illustrates a back of the device illustrated in FIG. 1, with the conforming skin being removed;

FIG. 3 illustrates a cartoon of system with selected data input factors for controlling display presentation; and

FIG. 4 schematically illustrates an overall process for user, environmental, and algorithmic control of a presented image, pattern or graphic on display;

FIG. 5 schematically illustrates another embodiment of a system for data storage and processing of a presented image, pattern or graphic; and

FIG. 6 schematically illustrates one embodiment of an image construction process including various automatic steps.

### DETAILED DESCRIPTION OF THE EMBODIMENTS

On flexible, semi-rigid, or rigid substrates, display systems as disclosed can present images or patterns based on user input, information obtained from social networks and other internet sources, and environmental indicators or cues. Such display systems can conform to objects, or can include curved or flat displays, alone or in combination. The presented images can be algorithmically constructed, for example, to match or clash with its surroundings; and then corrected, for example, for color errors arising from camera capture issues and geometric distortions arising from contouring. In some embodiments, displays can be temporally or environmentally adjusted automatically or semi-automatically based on changing conditions.

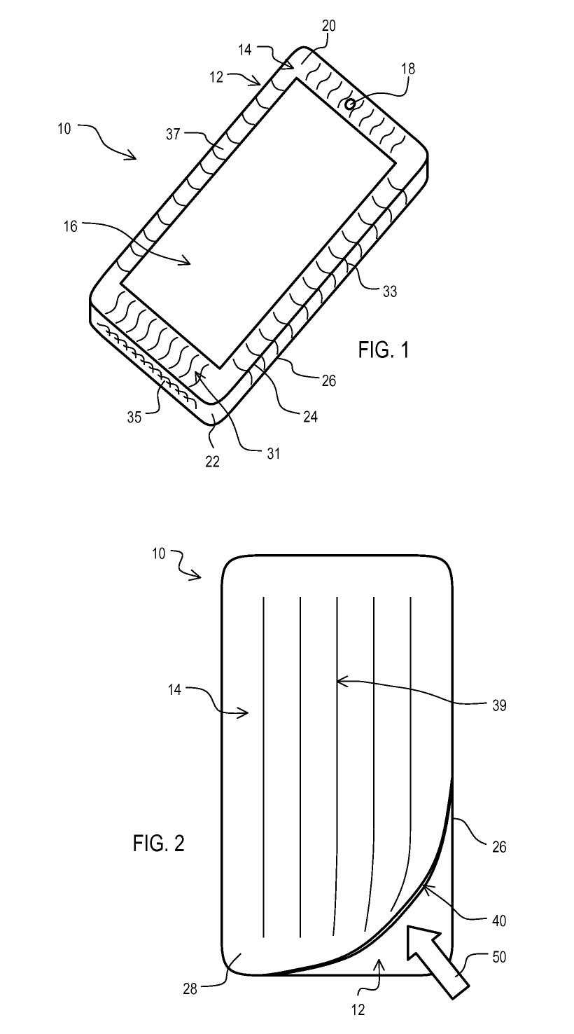

One embodiment is illustrated in FIGS. 1 and 2, which respectively show a front and back of a portable device 10 that has local information or data processing, sensing, and image capture capability, as well as permanent or intermittent contact with non-local information networks such as the internet, other linked devices, the telephone network, radio or television broadcast, or GPS location services. Information transfer can be through wireless radio or optical links, transfer of memory storage units, or wired connection. Preferred connections are through user initiated 3G or 4G or subsequent internet service links that allow for two way transfer of information, and permit access to distributed web sites or data cloud services.

The portable device 10 includes a housing 12 that supports both a flexible and removable (skinnable) display 14 and a conventional flat display 16. Both flexible and removable displays can be based on OLED, LCD or any of the various bistable display technologies, commonly known as “e-ink”, like those found on widely available book readers. As will be understood, displays 14 and 16 can independently or cooperatively present display information in accordance with this disclosure. While not shown in the Figures, the housing 12 includes all electronics, data processing modules, wireless or wired links to data processing modules, display controllers, power supplies, sensors (e.g. temperature or level position sensors) or actuators (e.g. vibrational elements) necessary for desired functionality. A camera 18 can be used to capture images, including images of people, the local environment, objects, colors, textual information, bar codes, or other locally derived visual information. In this embodiment, the skinnable display 14 is formed as a flexible wrap that partially surrounds the housing 12 and conventional display 16, with a front surface 20 extending to wrap around edges 24 and 26 (which define an edge surface 22) and extending to a back surface 28. The skinnable display 14 includes addressable pixels that can modify gray level, color, brightness and other visual attributes to display a wide range of colors, patterns, images, and symbolic or textual information. The display 14 can be formed from LCD, OLED, bi-stable displays, including e-ink's bi-stable technology, or other suitable display technology as later discussed. In this embodiment, representative wavy patterns are generally indicated by arrow 31. The patterns 33 can wrap around edges, and can be distinct in color or pattern (e.g. overlapping lines 35, narrowly set curved lines 37, or straight lines 39). In certain embodiments the patterns (e.g., 33) can be optionally coordinated with the displayed background or images of the conventional display 16. As seen in FIG. 2, in the embodiment shown, the skinnable display 14 conforms to the housing 12, yet is still flexible enough to be peeled away along edge 40 and removed as generally indicated by arrow 50.

As will be appreciated, the skinnable display 14 can at least in part be flexible to allow conformal wrapping around a device. It may comprise structures as a single or multiple layers, film, foil, sheet, fabric, or a more substantial, preformed, three-dimensional object that can still bend. It may be electrically conductive, semi-conductive, or insulative as appropriate for the particular implementation. Likewise, the substrate may be optically transparent, translucent or opaque, or colored or uncolored, as appropriate for the particular implementation. Suitable substrate materials may be composed, for example, of paper, plastic, metal, glass, rubber, ceramic, wood, synthetic and organic fibers, and combinations thereof. Suitable flexible sheet materials are preferably durable for repeated imaging, including for example resin impregnated papers, plastic films, elastomeric films (e.g., neoprene rubber, polyurethane, and the like), woven fabrics (e.g., cotton, rayon, acrylic, glass, metal, ceramic fibers, and the like), and metal foils.

In alternative embodiments, some portion of the display is substantially rigid, while in still other embodiment the skinnable display can be completely rigid, and is embedded or fitted to surround the device. In preferred embodiments, the skinnable display has an electrically modulated imaging layer on at least one surface. A suitable material may include electrically modulated and electronically addressable material disposed on a suitable support structure, such as on or between one or more electrodes. In still other embodiments, a display device can be one or more flat conventional displays.

In certain embodiments, a skinnable display is formed on a flexible, rigid, or semi-rigid plastic substrate such as polyethylene terephthalate (PET), polyethylene naphthalate (PEN), polyethersulfone (PES), polycarbonate (PC), polysulfone, a phenolic resin, an epoxy resin, polyester, polyimide, polyetherester, polyetheramide, cellulose acetate, cellulose acetate butyrate, aliphatic polyurethanes, polyacrylonitrile, polytetrafluoroethylenes, polyvinylidene fluorides, an aliphatic or cyclic polyolefin, polyarylate (PAR), polyetherimide (PEI), polyethersulphone (PES), polyimide (PI), poly(ether ether ketone) (PEEK), poly(ether ketone) (PEK), poly(ethylene tetrafluoroethylene) fluoropolymer (PETFE), and poly(methyl methacrylate) and various acrylate/methacrylate copolymers (PMMA). Although various examples of plastic substrates are set forth above, it should be appreciated that the areas of the substrate can also be formed from other materials such as fibers, for example, glass or quartz fibers, and fillers, for example, carbon, graphite and inorganic particles.

In other preferred embodiments in which rigid or semi-rigid skinnable displays are used in conjunction with a device, the less flexible area is preferably flexible metal, metal foil, polyethylene terephthalate (PET), polyethylene naphthalate (PEN), polyethersulfone (PES), polycarbonate (PC), polysulfone, phenolic resin, epoxy resin, polyester, polyimide, polyetherester, polyetheramide, and poly(methyl methacrylate). The more flexible area is preferably cellulose acetate butyrate, aliphatic polyurethanes, polyacrylonitrile, polytetrafluoroethylenes, polyvinylidene fluorides, aliphatic or cyclic polyolefin, polyarylate (PAR), polyetherimide (PEI), polyethersulphone (PES), polyimide (PI), high density polyethylene (HDPE), low density polyethylene (LDPE), polypropylene and oriented polypropylene (OPP) or similar plastic.

In certain embodiments, electrically modulated imaging layer can be liquid crystal displays (LCD) that comprises a liquid crystalline material that undergoes conformational changes in response to electrical addressing of pixels. Liquid crystals can be nematic (N), chiral nematic, or smectic. Chiral nematic liquid crystal displays can be reflective, so a backlight is not needed. In other embodiments, organic light emitting diodes (OLEDs) can be used, with electrical addressing pixels directly resulting in luminescent response. OLEDs can be manufactured to include several flexible layers in which one of the layers is comprised of an organic material that can be made to electroluminesce by applying a voltage across the device. The light-emitting layer of a luminescent organic solid, as well as adjacent semiconductor layers, can be sandwiched between an anode and a cathode. The light-emitting layers may be selected from any of a multitude of light-emitting organic solids, for example, polymers that are suitably fluorescent or chemiluminescent organic compounds. When a potential difference is applied across the cathode and anode, electrons from an electron-injecting layer and holes from the hole-injecting layer are injected into the light-emitting layer; where they recombine to power efficiently emit light.

Because of their low cost, low power, ruggedness, and durability, bistable displays are preferred for many applications. The electrically modulated material may also be a printable, conductive ink having an arrangement of particles or microscopic containers or micro capsules. Each micro capsule contains an electrophoretic composition of a fluid, such as a dielectric or emulsion fluid, and a suspension of colored or charged particles or colloidal material. Alternatively, a bistable display can be formed from electrically modulated material may also include material such as disclosed in U.S. Pat. No. 6,025,896. This material comprises charged particles in a liquid dispersion medium encapsulated in a large number of microcapsules. The charged particles can have different types of color and charge polarity. For example white positively charged particles can be employed along with black negatively charged particles. The described microcapsules are disposed between a pair of electrodes, such that a desired image is formed and displayed by the material by varying the dispersion state of the charged particles. The dispersion state of the charged particles is varied through a controlled electric field applied to the electrically modulated material.

Further, the electrically modulated material may include a thermo-chromic material. A thermo-chromic material is capable of changing its state alternately between transparent and opaque upon the application of heat. In this manner, a thermo-chromic imaging material develops images through the application of heat at specific pixel locations in order to form an image. The thermo-chromic imaging material retains a particular image until heat is again applied to the material. Since the rewritable material is transparent, UV fluorescent printings, designs and patterns underneath can be seen through.

In still other embodiments, displays can include tactile features that raise or lower the display surface to enhance or create novel image patterns. This would allow, for example, visual properties of a stripe or line pattern to be augmented by physically raising or lowering the stripes or lines. Such display systems can be based, for example, on electroactive polymers, or underlying, overlying, or integral polymeric, piezoelectric, capacitive, or other micromechanical actuators. Expansion, contraction, tensioning, or compressive actuation elements can be used, alone or in combination with each other. Such tactile displays can even be used to create shadowing or other visual features without associated pixel imagery.

As will be appreciated, a housing or device can support multiple displays. These can be of the same or different type, and can be tiled or disjoint as required. The displays may employ any suitable driving schemes and electronics known to those skilled in the art.

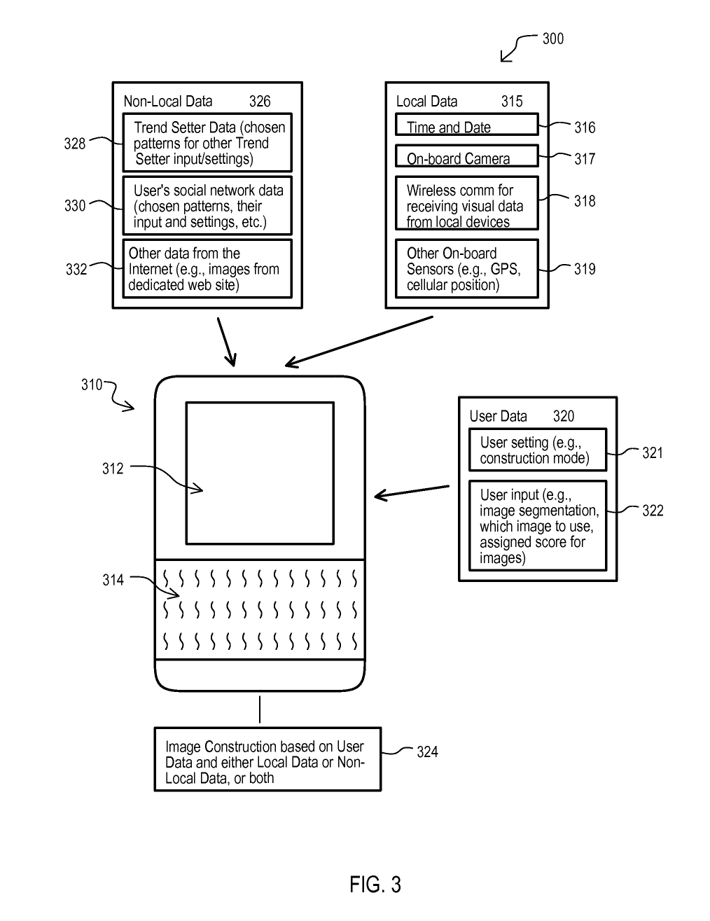

FIG. 3 illustrates one embodiment of a system 300 with a device 310 having local data processing capability and/or a link to a remote data processing module capable of supporting functionality of devices according to FIGS. 1 and 2, or other devices such as described herein. As seen in FIG. 3, a device 310 includes an LCD, OLED, or other traditional display screen 312. The device 310 also includes a conformal, wrap around display 314 that can be operated independently or in conjunction with display 312. The device 310 can receive, generate, or transport data between varieties of external data sources, including GPS positioning satellites, cellular networks (e.g., 319), or internet or cloud mediated social network data sources (e.g., 330, 332). In addition, device 310 may include a source of local data 315 (e.g. a hard drive, flash memory, embedded DRAM, or other known data retention systems) that can optionally retain data based on on-board cameras (e.g., 317), other sensors (e.g., 319), direct user input or user-specified preferences. Local data 315 can also include other system information, such as time/date, software/firmware version (e.g., 316). The device 310 can locally or through remote wired or wireless connection construct 318, correct and adjust images based on these data sources for presentation by displays 312 or 314. Image construction 324 for the displays is based on various sources of non-local 326 and local data 315, including user input and preferences (e.g., 320, 321, 322); elements of randomness may also be involved in image construction. Image corrections can include deterministic modifications such as rotation, translation, scale, color, brightness, or accounting for contour-based effects. Image updates can be random, semi-random or deterministic, and can be made in response to, for example, changes in local-data such as updated images captured of the local environment, and changes to non-local data, such as recent patterns which are being chosen within the user's social network (328, 330).

As will be appreciated, while the illustration shows a small electronic cell phone or the like, the device 310 is not limited to cell phones, and can have a wide variety shapes, sizes, and functions. Device 310, can include, for example, small portable electronic devices such as cellular telephones, data or media storage devices (e.g. flash drives or music player devices), security badges, gift cards, identification cards, medical status tags, cameras, watches, or media tablets, electronic notepads, and laptops. Larger devices can include electronic devices such desktop computers, computer monitors, televisions, digital video recorders, or audio systems. In certain embodiments, small mobile or robotic devices can support a display. Displays can be incorporated as decorative or functional elements in a variety of covers, cases, furniture, carryable items such as purses or luggage, vehicles, automobiles (including, for example, external doors and surfaces, or internal dashboards or seat backs). Clothing, apparel or other wearable items such as belts, bracelets, scarves, hair clips, or the like can also support skinnable displays. Architectural applications are also possible, with buildings, ceilings, floors, stairs, doors, or internal or external walls capable of supporting displays.

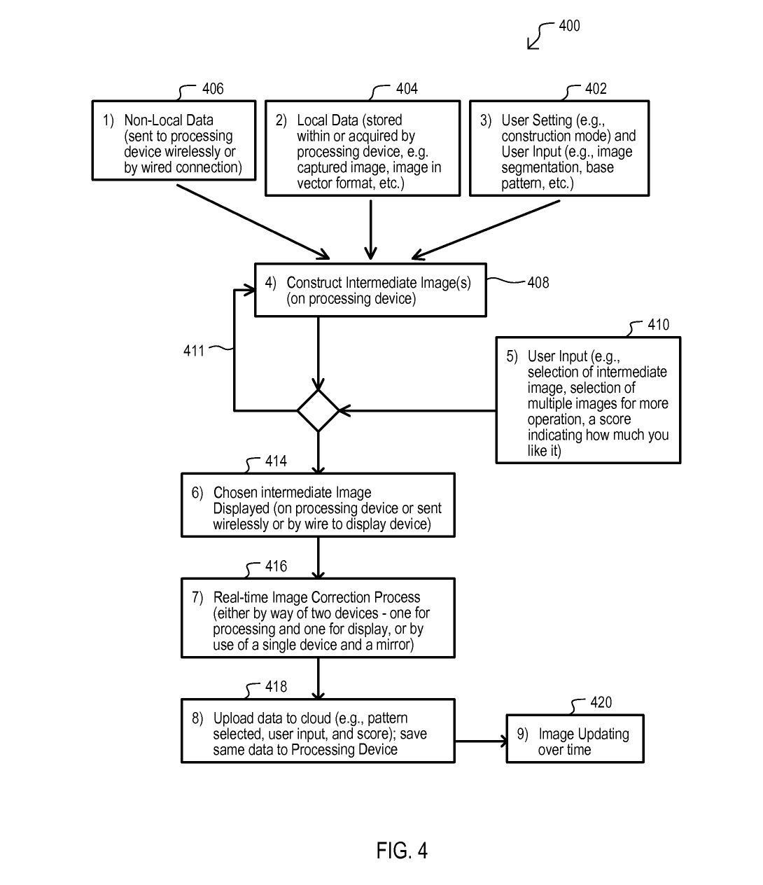

One embodiment of a generalized process 400 for determining the pattern or image presented on the skinnable display is disclosed in FIG. 4. All of the steps 1-9 disclosed in FIG. 4 are not required for operation of systems according to this disclosure, and certain steps may be omitted or selectively modified in particular embodiments. It should be noted that the user providing initial user input can differ from a user providing real-time input. For example, the initial user input could be set by a manufacturer, a remotely located person, or another locally present individual with direct or wireless access to a device input settings (e.g., via Bluetooth mediated personal area networks or the like).

The initial user input 402 can include, but is not limited to, assignment of image construction modes, preference selections such as brightness, color selections, or image selection criteria, including favorite images, graphics, or patterns. Other examples of user input can include user-specified segmentation of images (e.g., use of touch screen to segment certain garments or patterns in the image, or segmentation of hair or eyes or other body parts; user input may also include directives about image construction criteria, the selection of intermediate images, and other useful parameters that aid in constructing a suitable image, pattern or graphic for display.

The user input can be entered directly on the device (becoming local data 404) or provided remotely (non-local data 406). Non-local data 406 may include, for example, images chosen by trend-setters, images chosen by those in a user's social network, or images obtained from a dedicated website. Local data may include, e.g., images of people with garments captured in a camera's field of view (FOV), images of desired patterns, previous images used for display (skinnable or otherwise), user-specified parameters that impact image construction, previous choices made by users among intermediate images, data collected by other sensors: audio, temperature, time of day, etc.

Non-local data 406 can be used alone or in combination with local data 404 to develop candidate intermediate images 408 for presentation on one or more displays. The Intermediate image can be selected 410 for presentation on the display(s) 414, and optionally, a local user can provide corrective input 410 (e.g., x-y scale, rotation) through available touchscreen, keyboard, tactile, or audio interfaces (or any other suitable human interface). If the user does not select or approve the intermediate image, a user request for additional images can be provided as indicated by arrow 411.

If desired, automated or semi-automated real-time image correction 416 can be employed by having two or more devices that can support cameras. A first display device can be imaged by a camera on a second device, and any perceptible irregularities or errors can be identified and corrected in a feedback loop. For example, misalignment of a pattern as it wraps around the first device can be identified, and the image or image control information can be sent from the second device to the first device to allow a more accurate alignment or correction to the image, which can then be checked again using this same process. Other corrections can include movement between multiple displays, or adjustments to compensate for distortion arising from 3D character of a skinnable display, or other distortions. When original content associated with input images in also in the same FOV, other corrections can include image scaling, translation, rotation, color palette selection, color remapping, brightness, or color saturation. As an alternative to using two devices, a first device can image itself with use of a mirror. In this case, the processing device is one-in-the-same as the display device, and the mirror allows the device to capture itself in the FOV of its camera.

Images may change over time 420 based on various factors, including but not limited to: time of day, time of year, temperature, changes in visual surroundings, direct user input (e.g., contact phone with signal indicating it's lost), etc. Using algorithmic, local or non-local data, the images can be modified over time. Finally, intermediate, final, and updated images presented on a display or which exists within a processing device can be uploaded to non-local data sites (e.g., 418) (or remain as locally stored data in certain embodiments). This allows a user or others in a user's social network or other's affiliated in some way to download and reuse the customized images, or use them as original content for subsequent image construction processing.

In other embodiments, non-local social network data is combined with local environmental input to construct an image, pattern or graphic. The local environmental input can be based on images, device orientation, location, sensed audio, temperature or the like provide input for determining display presentation. A color, pattern, image or graphic is selected based the environmental input data and combined with the non-local data (which may include social or other network derived data). An image, pattern or graphic is then manually, semi-automatably, or automatably created on the display. In certain embodiments using conforming or skinnable displays, the three dimensional configuration of the wrapped display is used to determine align or positioning of the image, pattern or graphic. For example, a pattern can be aligned so that blank spaces are positioned on the wrapping edge, or facial images are moved and scaled to fit onto a large, relatively flat portion of the display to minimize undesired distortion. The particular color, size, arrangement, or other image, pattern or graphic property can be further modified by environmental data, user input, or algorithmic input, and the modified pattern so created can be locally stored or non-locally stored on an internet or other network for later use by a user or members of the user's social network.

As another particular example, local data can be used to determine a pattern by taking an image or video stream and detecting people by pattern analysis or by reliance on user input by segmenting pattern section from rest of image (e.g., finger on touch screen inscribing the pattern). If people are detected in an image, clothing colors or patterns can be identified and isolated, and the patterns and colors used to derive a new pattern(s) for a skinnable display. Alternatively, images or patterns can be selected from a library, or a user can select one or more of the patterns for pattern fusion or differentiation. Derivation of matching pattern can be based on a wide variety of inputs, including but not limited to clothing in images, user selected clothing subsets in an image, skin, hair, and eye color of a user, including use of algorithm-injected randomness. Alternatively, user-specified directives to match, clash, etc. with original input patterns, or user-selected modes like chameleon, complement, contrast, etc., can be selected. Patterns can be electronically stored on a camera device, or elsewhere; be based on previous pattern choices by user; recently chosen by those in user's social network; recently chosen by celebrities or other trend-setters; or based on other internet-derived information. In other embodiments, locally detected emotion (facial expression) of user in image, ambient sounds, movement, temperature or the other sensed data can be used as original input or for adjusting an image. Patterns can also be compatible with a sensed or detected situation. Preset or derived patterns to indicate loss of a device (e.g., can display in large red font a number to call if found), an unauthorized user, or emergency pattern modes (flashing, brightly colored) can based on environment to maximize visual effect.

Display image can be adjusted by a real-time feedback loop involving display and source of original input image (e.g., user's clothes) both in field of view (FOV) of device-supported camera which is performing real time processing (to adjust tilt, rotation, color, contrast, grayscale, brightness, x-y scale, etc.) and continuous uploading of adjusted images to device with skinnable display. In this case camera device will need to wirelessly communicate with display. Alternatively, a feedback loop involving camera device with its display surface imaging itself in a mirror with raw input patterns in FOV (in this case the display can do something so that the detection algorithm can easily find it in the FOV; e.g., flash black-and-white until detected). User-based touchscreen or gesture control in camera device FOV can be used to rotate, skew, or change scale of pattern. Automatic centering of images (for pictures of people, animals, or objects) and wrapping/aligning patterns to smoothly map onto three dimensional is also possible.

The display can be two dimensional, wrapped at least partially around a three dimensional device, or even repositioned on such surfaces. Given the potential variety of geometric attributes for the display, a wide variety of image processing algorithms can be useful, including both open loop and closed loop techniques. In both open and closed loop techniques, images are broken down into primitive constructs. These primitives can be rotated, stretched or manipulated in other ways, and brought into contact with each other in different ways. In the closed loop approach, the rules that define primitive generation and manipulation can be based on local learning and environmental feedback learning, or can alternatively or in addition be driven by direct user input or a history of transformations previously preferred by a user or group of users. In the open loop approach traditional design rules (e.g. don't mix stripes and plaids) can be implemented in the algorithm to automate the process. Operations that can be implemented include setting alignment/orientation of the display, perspective mapping, or UV mapping. If the display is removable, inputs should allow the display to dynamically adjusting to new object size and placement by user or automatic input (e.g. automatically adjust for differences between flat and cylinder wrap). Real-time imaging and feedback can also be utilized: specific patterns can be sent to device allowing the imaging system to quickly and correctly understand the 3D surface through image processing, arrange to accommodate for seams, transition zones, curved areas, or concealed areas of the display when wrapped around a device. Suitable algorithms or users can compensate for misalignment and rotation of patterns. In some embodiments, optical effects such as receding colors or patterns, or perspective or three dimensional mapping can be used. Real-time imaging and feedback can be utilized: specifically-patterned images can be sent to device allowing the imaging system to quickly and accurately understand the 3D surface through image processing. Over time displayed patterns could be updated with the update period being based on user input or as a function of power drawn from bi-stable display medium (i.e. update at rate such that only so much power is drawn), or updates could be triggered aperiodically by changes in local and non-local data. An example of non-local data change would be socially derived spring color data is replaced by summer patterns over the course of a few months. An example of a local data change would be changes to content in FOV or environment (e.g., increase in noise modifies pattern) can result in display changes. Patterns can change based on other measurements as well, including position, speed or velocity, identity or status of the user or device holder (e.g. a borrowed device is a different color than owned device).

In still other embodiments, when devices get near one another in proximity they “collaborate” based on user-specified directives (e.g., they may morph towards each other to match, or they may diverge away from each other to clash). Multiple devices can indicate update/coordination by simultaneous pattern or colors derive their appearance from its surroundings (including its owner) and/or its function. In some embodiments, when two devices come in proximity, and if respective user social data bases indicates they are compatible, then images related to interests can be displayed.

Active user input or control is not required in certain other embodiments. For example, multiple robotic devices can also self-coordinate on each other's displayed image/pattern. In such cases of coordination, images can be shared purely electronically as a superior approach to camera-based image capture, which introduces measurement error in the process.

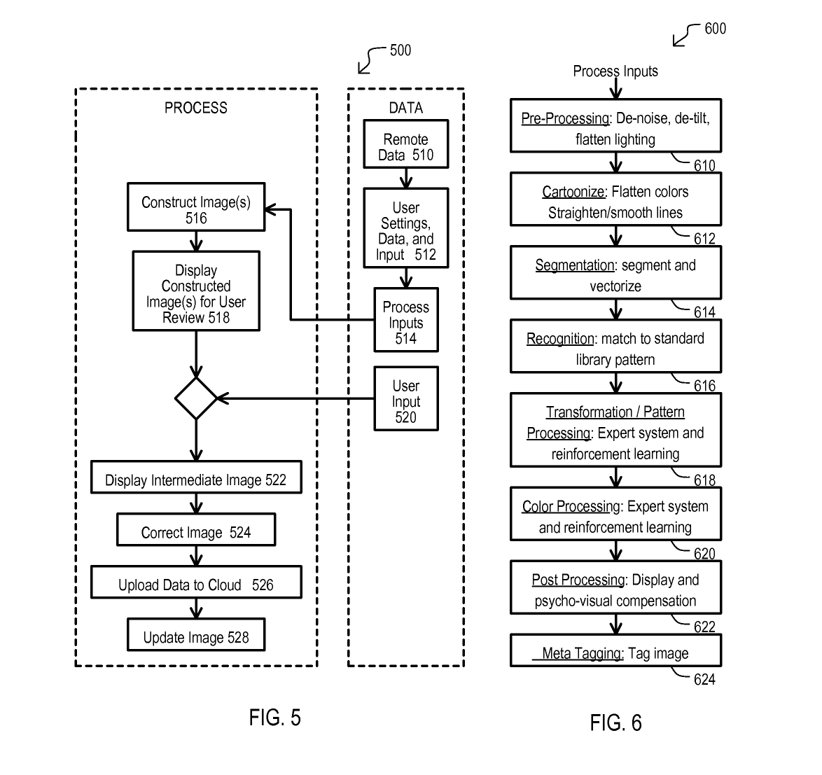

Another embodiment of a general system and process 500 for providing visually adapted surfaces is illustrated with respect to FIG. 5. Various platforms, process, and data together interact to provide a system for visually adaptive information. Platforms can include one or more processing devices (e.g., phone, tablet, laptop, computer, wrist watch, MP3 player, eye or sun glasses equipped with electronics, etc.), one or more display devices (e.g., phone, tablet, laptop, computer, wrist watch, MP3 player, eye or sun glasses equipped with electronics, photo frame, monitor, TV, automotive components, interior building walls, etc,) which can be separate from, or one in the same as the processing devices), or the cloud. The cloud can be the internet, any intranet, ad-hoc network, or other system capable of storing and transferring data, and providing data and primary or auxiliary processing power for the disclosed process embodiment and data. Depending on the application any data may be stored or any step of the process can be run in the cloud, with the processing device and/or display device offloading computation or data storage/retrieval to the cloud.

As seen in FIG. 5, process inputs 514 can include the complete set of data (stored within the processing device and/or cloud), possibly acquired by sensors, wired or wireless communication, other hardware elements, or user input, which drives the image construction process. Process inputs include various kinds of data, including but not limited to location of the user, time of day (at user's location), day of year, remote data which has been downloaded to the processing device. Process inputs can also include user settings and user data as well as real time user input. Process inputs may also include display device data so that image construction can appropriately accommodate for various features such as its curved surface, seamed edges, size, resolution, color gamut, etc. Remote data 510 is not principally stored on the processing device. Remote data can include but is not limited to data originated outside of the device, large data sets not storable on the processing device, data that changes quickly, data that is better handled remotely for security, reliability, or user-convenience reasons, data derived from social networks, or any other source of non-local data. Some or all of the data can be downloaded to the processing device as needed in data subsets, at which point the remote data becomes part of process inputs. Examples of remote data 510 can include:
1) The user's historical intermediate image selections, and the associated conditions surrounding each of those selections, such as all of the process inputs and those images reviewed but not selected (this information is important to any automated learning processes that occur in the cloud or on the processing device);
2) Historical image choices of other users, and the associated conditions (this information is important to any automated learning processes that occur in the cloud or on the processing device);
3) Patterns, colors and images which are currently trending across the base of all users
4) Location-based patterns, colors, and images. These are more persistent than trending patterns, colors and images. For example aquatic-themed patterns, colors and images associated with seaside locations;
5) Location/time-based patterns, colors, and images. These are less persistent then trending patterns, colors and images. For example, it might be pro sport team colors during a sporting event in the vicinity of the team's stadium;
6) Other images, patterns and colors stored in the cloud, such as those submitted by other users or sponsored by corporations for piloting or branding purposes, or automatically by processing devices;
7) Environmental or event-based data such as weather information or other current event information, such as sporting events and associated team logos (which may be images intended to be resized and centered in the display).

User settings 512 are data that include settings set by the user for use in image construction and review, for image updating, and other processes. The data may be stored in the processing device or in the cloud. The settings can include:
1) Image construction mode, which sets guidelines for image construction, indicating requirements to, for example, match (i.e., in a fashion coordination sense), contrast (in a fashion faux pas sense), or camouflage, to the input image(s);
2) Rank ordering of favorite patterns, favorite colors, favorite images, and the number of constructed images the user wants to review per screen during the intermediate image selection process;
3) Rank ordering of favorite trend-setters;
4) Various toggles signaling whether and/or how to incorporate (during image construction) various data including, but not limited to, the user's historical behavior, the local weather, colors/patterns associated with location and/or location-time of user, trending patterns/colors/images, and also those trending patterns/colors/images filtered by location (globally/countries/cities), age group, gender, fashion style, relationship status, or other user data. Other toggles can signal to include colors/patterns/images recently being selected within the user's social network, or recently selected by the user's trend-setters;
5) Various image construction coefficients, including those related to pattern morphing, pattern randomness, color morphing, and color randomness. The pattern morphing coefficient dictates the degree to which image construction will modify/manipulate favorite patterns, implicit favorite patterns (with “implicit” meaning patterns preferentially selected by a user during the intermediate image selection process), patterns found/selected inside of input image(s), trending patterns, and any other patterns used during image construction in order to fulfill the construction mode and to create images which will be seen favorably by the user. The pattern randomness coefficient similarly controls the degree to which image construction will incorporate patterns which appear random relative to favorite patterns, implicit favorite patterns, patterns found/selected inside of input image(s), and any other patterns used during image construction. This feature is of particular importance for the automated algorithm learning process, since the user gets exposed to new patterns and the system can monitor the user's selection of intermediate images. Like pattern morphing and randomness, the color morphing coefficient sets the degree to which image construction will modify favorite colors, implicit favorite colors, colors found/selected inside of input image(s), trending colors, and any other colors used during image construction in order to fulfill the construction mode and to create images which will be seen favorably by the user. Similarly, the color randomness coefficient sets the degree to which image construction will incorporate a set of colors which appear random relative to favorite colors, implicit favorite colors, colors found/selected inside of input image(s), and any other colors present in process inputs. Again, this is useful in the learning process, since the user is exposed to new colors.
6) The update mode which sets the manner in which a displayed image is updated. Modes may include, but are not limited to, in order of increasing degree of automation: Manual, Automatic Generation, and Automatic Updating.
7) Event-based or time-based triggers can be set which determine when the (automatic) image update process is initiated. Triggers may include for example: time-of-day or day-of-year, change in user location (relative to location at last update), change in user's location-time (relative to location-time of last update), a pattern/image chosen by a user's trend-setter, changes in trending patterns/colors/images (relative to status of trends at last update), changes in processing device's field-of-view contents (relative to time of last update), changes to other external variables such as weather, direct signal sent to the device (for example a signal indicating the device is lost—in this case the device might try to visually stand out from its surroundings), when two or more processing devices get in close proximity of each other (either detected autonomously between the devices, or via centralized processing in the cloud) this triggers a “collaboration” for their visual appearance based on the construction mode (e.g., they may morph their displayed image towards each other to match, or they may diverge away from each other to clash), collaboration between 2 or more devices might depend on something other than proximity (in these cases processing could be centralized in the cloud), and the processing device's assessed identity of the person holding the processing device.

User data 512 is a collection of user attributes, characteristics and behavior. The data may be stored on the processing device or in the cloud. User data includes:
1) user's birthday, gender, home town, current location
2) user score (automatically determined based on other users selecting them as a trend-setter and the degree to which other users employ patterns or images associated with the user)
3) fashion style (explicitly set by the user)
4) implicit fashion style (automatically determined based on the user's selection of intermediate images and other choices)

User input 512 refers to one or more input images and/or patterns which are provided as input for image construction; the construction mode is relative to these inputs. These images may be marked in some way by the user to isolate certain images, patterns, and/or colors.

The data can be collated and prepared to provide process inputs 514 to the image construction process, which based on this data automatically creates one or more images for review and possibly selection by the user. As seen in FIG. 5, a construct images step 516 is followed by a step of displaying constructed images for user review 518 on the screen of the processing device. The user can then choose (step 520) the intermediate image to be displayed (step 522) on the display device. The intermediate image can be corrected (step 524) using a real-time feedback loop which minimizes image capture error and distortions arising from display surface curvature, and the finalized image and associated conditions can be uploaded to the cloud or other data location (step 526). Based on the update mode and assigned triggers, the displayed image over time may go through update processes (step 528).

One embodiment of a generalized process 600 for determining the pattern or image (referred to as image construction) presented on a display is disclosed in FIG. 6. All of the steps disclosed in FIG. 6 are not required for operation of systems according to this disclosure, and certain steps may be omitted or selectively modified in particular embodiments. As can be seen, process inputs (601) are provided and input image(s) undergo a series of operations. These steps can include preprocessing 610 to prepare an image by noise reduction, de-tilting, or light flattening. Step 612 takes the adjusted image and cartoonizes it by flattening colors, straightening or smoothing lines, and removing or otherwise simplifying high frequency features. Segmentation 614 can be a next step, which includes vectorization of the processed image. Recognition of image elements 616 can include direct comparison of the image to library patterns. In certain embodiments, image recognition can be provided through automatic identification of repeating images, motifs, self-similar structures. In still other embodiments important image elements can be identified by a user. The now identified or marked pattern can be transformed in step 618 using expert systems or algorithmic guidelines that are based on user settings and data, and remote data (e.g., a greyscale patterns that result from this process can then be colored based on step 620). Post processing 622 can adjust the image for human psycho-visual limitations (e.g. reducing resolution for displays intended to be seen from a distance, while increasing effective resolution for displays that are intended for close inspection). The image can be meta-tagged in step 624 to simplify, for example, later retrieval and indexing or categorization by a user or dedicated web site (which aggregates the images).

Further examples are discussed below, the disclosures of which are not intended to be limiting, but instead show useful aspects allowed by practice of the disclosed system, process and apparatus.

### EXAMPLE 1

A skinnable display can be constructed to allow a slip-on, friction-fit, latch or catch, inlay, adhesive application or other conventional permanent or temporary mechanism to attach to a device. The display may include a power and signal interface required to the device (via wired or wireless connection), or can be independently powered and able to communicate with systems capable of providing image data. Such skinnable displays are particularly useful as add-on or options to original equipment manufacturer (OEM) electronic devices or other suitable support structures such as purses, wallets, or bags. The skinnable display can be, for example, slip-fit around a laptop to provide for ready user customization of color or laptop case patterns.

### EXAMPLE 2

When two devices come in proximity, and if their social network (or other information source) database indicates they have compatible likes or interests, images related to interests can be fused together on one of the surfaces. This provides a conversation piece while also showing their interests to one another, which are matched or estimated as compatible. Alternatively, a game or other two-person interactive application can be displayed on a surface, allowing engagement by both persons.

### EXAMPLE 3

Social or professional (colleague) network web sites can show who is wearing what, or suggest alternate patterns which work well, including individual or social network determined objectives (match well, clash, similar pattern/different color, similar color, different pattern). In certain embodiments the collected data could be made accessible to fashion industry persons or companies, or other organizations interested in clothing trends.

### EXAMPLE 4

Vehicles can be customized with external and internal displays according to this disclosure. For example, vehicle door advertising signage can modify itself for more prominent display according to geographic location, lighting conditions (e.g. black text on white background in daylight, and white text on black at night), with ambient light conditions being dynamically sensed by an attached camera, or set from GPS or onboard clocks. Internal surfaces, particularly including curved dashboards or other surfaces can be fitted with color changing displays that can change images or patterns according to this disclosure.

### EXAMPLE 5

Robots can be customized with display surfaces on their bodies. They can then automatically change their appearance based on, for example, their surroundings—including the clothing of their owner—and their current function. In the case of using the owner's clothing as input, the resulting image, pattern or graphic can be calculated to either match or complement the style of the owner's clothes. Additionally, robots can coordinate on each other, electrically sharing information about their appearance then mutually adjusting their appearance to possibly match one another, or perhaps to further distinguish each from the other.

### EXAMPLE 6

Architectural applications are also contemplated, with external and internal displays possible. Walls, ceilings, doors, windows, can have displays attached. In other embodiments, flexible displays can be permanently or temporarily attached, including drapes, hanging fabric, or other movable architectural features can be dynamically adjusted to display new images and patterns in response to changing environmental cues, or user or social data mediated status changes.

### EXAMPLE 7

A user can start her day by taking a picture of herself after getting dressed in the morning. She wants her phone to match her outfit—blue jeans with a pink sweater. She starts the app on her phone and selects this photo as the input image. She has polka-dot set as her favorite pattern, and pink and red set as her favorite colors. The first four images include 1) pink (favorite color and color of her sweater) background with blue (jean color) polka dots (favorite pattern), 2) blue background with pink polka dots, 3) red (favorite color) and blue striped pattern (one her of designated trend-setters chose a striped pattern earlier that morning) and 4) pink and blue striped pattern with thicker lines and a color blend between the transitions (based on a large pattern morphing coefficient). Not particularly excited by any of these suggestions, she provides user input requesting to see the next set of four candidates. The first of the new four suggestions includes a pink and blue saw-tooth pattern. The saw tooth pattern is something she has chosen frequently in the past, especially under conditions wherein the input image is absent of pattern information. She immediately accepts this suggestion and the phone's adaptive surface displays it.

### EXAMPLE 8

Coordinating selections with a friend before going out for the evening is another possible use of described embodiments and methods. For example, a user Mia can start a phone application to take a picture of herself and Beth. They use the touch screen interface to delineate their shirts from the rest of the image; Mia is wearing a green shirt and Beth is wearing a blue shirt. The construction mode is set to “Match” and the Mia is presented with various patterns using the colors of the two shirts, among other colors. Mia selects a blue and green checkerboard pattern and it gets displayed on her phone. Beth has Mia designated as a trend-setter, so moments later Beth gets a notification regarding Beth's activity and is asked if she would like to display the same image. Beth accepts the new image and now they are using have matching phones, which also coordinate with their outfits.

### EXAMPLE 9

Updating phone configurations at an event is another contemplated scenario. For example, User Joe may have selected an image for display in the morning. On Sunday afternoon he arrives at a football stadium to see a game. The GPS location data provided by the phone, in association with calendar and clock information can trigger an image update based on special location and special time. Without any input from Joe, the phone accesses the cloud and pulls up location-time-specific images. In this case, images with high implicit scores are centering images containing the logo of the local football team. As noted in this disclosure, centering images are a special kind of input image which is meant to be centered (and other than resizing or repositioning, mostly un-altered) in the constructed image(s). Normally no more than one centering image would be included in process inputs. Image construction would center this element in the center of the constructed image(s) and can blend the logo into its surroundings using a favorite pattern and favorite color that complements the appearance of the logo. Joe receives a notification and is presented with suggestions for new images to display. He selects an image combining the logo and a sun ray pattern in the background. This pattern was included in image construction because the weather forecast showed no clouds in the sky at Joe's location and because it matched well with the team logo.

### EXAMPLE 10

Visually adaptive surfaces can be associated with permanently or semi-permanently mounted decorative appliances or structures. For example, a wall mounted or table supported photo frame can have a visually adaptive surface that extends around its bezel. The photo frame is connected to the cloud and when a baby portrait becomes the image shown, eye detection is performed and the color of the baby's blue eyes are used as a color for image construction processing. The user account associated with this photo frame indicates that's the baby cloth pattern is often used involving images of babies. The photo frame bezel is automatically updated using this pattern and the blue hue of the baby's eyes.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Accordingly, the specification and drawings are to be regarded in an illustrative rather than a restrictive sense.

What is claimed is:

The claimed invention is:

1. A display system comprising
a display that is curved, and
a processing module to automatically create images to present on the display based on a set of rules operating on data selected from the group of: stored user settings, input from a user, local sensor data including images captured by a user, or social or other network derived data.

2. The display system of claim 1 wherein the display is removable from an article, and at least partially conforms to a surface of the article.

3. The display system of claim 2 wherein the processing module provides three dimensional modification of an image to display on a non-flat surface of the display.

4. The display system of claim 1 wherein the display is bistable.

5. The display system of claim 1 wherein the processing module is configured to process both local images captured by a user and non-local data to create images for presentation on the display.

6. The display system of claim 1, wherein the processing module is further configured to create and display an intermediate image for approval by a user, with an approved image being modified to display on the display.

7. The display system of claim 1, wherein the processing module accepts input from a user to display an intermediate image, with the image adjusting in response to a real-time feedback loop involving the display in the field of view of a camera providing data.

8. The display system of claim 1, further comprising a second display and processing module to interact and modify its display with respect to the curved display.

9. The display system of claim 1, wherein the processing module inserts random elements for construction of an intermediate image.

10. A display system comprising
a removable display that at least partially conforms to a curved surface of an article, and
a processing module to automatically create images to present on the display based on a set of rules operating on data selected from the group of: stored user settings, input from a user, local sensor data including images captured by a user, or social or other network derived data, and create an intermediate image for approval by a user, with the approved image being modified to conform to a three dimensionally curved surface of the display.

11. The display system of claim 10 wherein the processing module is configured to process at least local sensor data to construct the intermediate image.

12. The display system of claim 10 wherein the processing module is configured to process at least non-local data to construct the intermediate image.

13. The display system of claim 11 wherein the processing module is configured to receive data from a camera directed at the removable display to provide a real time modification of an image.

14. An image display system comprising
a display attached to an article,
a processing module to automatically create images to present on the display based on a set of rules operating on data selected from the group of: stored user settings, input from a user, local sensor data including images captured by a user, or social or other network derived data, and
a system including the set of rules to create an intermediate image that is presented to a user for approval, followed by along with image post-processing to compensate for visual characteristics of the article-attached display, with data relevant to the selected or post-processed image remotely stored for later retrieval by the user or others, including other processing modules; wherein
the system is selected from the group of: an automatic system and an expert system.

15. The image display system of claim 14, wherein the processing module accepts local images generated by a user, and combines the images with non-local data to automatically create images for display

16. The image display system of claim 14, wherein the processing module is further configured to create and present on the display an intermediate image for approval by a user, with an approved image being modified to conform to a curved surface of the display.

17. The display system of claim 14, wherein processing module is further configured to create and present on the display an intermediate image based at least in part on random elements.

18. A method for image processing images for a display attachable to an article, the method comprising the steps
providing data including at least one of stored user settings, input from a user, local sensor data including but not limited to images captured by a user, or social or other network derived data, and
using a set of rules to automatically act on the provided data to create an intermediate image that is presented to a user for approval, along with image post-processing to compensate for visual characteristics of the article attached display.

19. The method of claim 18, further comprising the step of storing data relevant to the selected or post-processed image for later retrieval by any selected from the group of: the user, others, and at least one processing module.

20. The method of claim 18, further comprising the step of accepting local images captured by a user, and modifying the images based on non-local data.

21. The method of claim 18, further comprising the step of modifying the intermediate image to conform to a non-flat display surface.

22. The method of claim 18, further comprising the steps of creating and presenting the display of the intermediate image based at least in part on random elements.

23. The method of claim 18, further comprising the steps of cartoonizing the image to simplify the image, segmenting the image to identify prominent characteristics, and matching the simplified and segmented image against a library pattern.

24. The method of claim 18, further comprising the steps transforming the one or more images using an expert system to adjust color or patterns.
